(19) United States
(12) Patent Application Publication
(10) Pub. No.: US 2025/0164639 A1
(43) Pub. Date: May 22, 2025

(54) SENSING SYSTEM AND CALIBRATION METHOD FOR POINT CLOUD AND IMAGE

(71) Applicant: METAL INDUSTRIES RESEARCH & DEVELOPMENT CENTRE, Kaohsiung (TW)

(72) Inventors: Wei-Te Chen, Changhua County (TW); Pin-Xian Lin, Chiayi City (TW); Chen-Shun Chen, Kaohsiung City (TW); Shang-Ching Chuang, Kaohsiung City (TW); Chen-Han Kuo, Kaohsiung City (TW); Yun-Hui He, Miaoli County (TW); Yao-Ming Wang, Kaohsiung City (TW)

(21) Appl. No.: 18/749,573

(22) Filed: Jun. 20, 2024

(30) Foreign Application Priority Data
Nov. 17, 2023 (TW) 112144536

(51) Int. Cl. G01S 15/86; G01S 7/52; G01S 15/89; G06T 7/80

(52) U.S. Cl. CPC G01S 15/86; G01S 7/52004; G01S 15/8906; G06T 7/80; G06T 2207/10028

(57) ABSTRACT

The invention proposes a sensing system for point clouds and images. The system includes a point cloud sensor, an image sensor, and a computing module. The point cloud sensor captures point cloud information of a target object. The image sensor captures a two-dimensional image of the target object. The computing module extracts three-dimensional feature points from the point cloud information and two-dimensional feature points from the two-dimensional image, and calculates multiple coefficients in a transformation matrix based on coordinates of the three-dimensional feature points and coordinates of the two-dimensional feature points. The computing module also performs a coordinate transformation process on the point cloud information or the two-dimensional image according to the transformation matrix.

### RELATED APPLICATION

This application claims priority to Taiwan Application Serial Number 112144536, filed on Nov. 17, 2023, which is herein incorporated by reference in its entirety.

### BACKGROUND

### Field of Invention

The present invention relates to sensing system and calibration method for point cloud and image.

### Description of Related Art

Point cloud is a data set composed of a series of points in three-dimensional space, and commonly used in various surveying and three-dimensional scanning technologies. Generally, each of the points of the point cloud has its definite position expressed in the form of X, Y, Z coordinates. The points are usually obtained from surface scanning performed on real-world objects, and can be used to capture and recreate the shape and appearance of the objects or environment. Point cloud data can be obtained through various methods, such as scanning by using a laser, scanning by using an optical scanner, scanning by using structured light scanning technology. However, the point cloud only has information about the shape of the object, and cannot sense the color of the object, texture of the object, and so on. An image sensor is required for obtaining the above information. If the point cloud data and the image are directly superimposed, it is easy to produce distortion, that is, the point cloud data and the image cannot be aligned. How to solve this problem is an issue concerned by those skilled in the field.

### SUMMARY

The invention provides a point cloud and image sensing system including a point cloud sensor, an image sensor, and a computing module. The point cloud sensor is configured to capture point cloud information of a target object. The image sensor is configured to capture a two-dimensional image of the target object. The computing module is communicatively connected to the point cloud sensor and the image sensor, in which the computing module is configured to extract a plurality of three-dimensional feature points from the point cloud information, and extract a plurality of two-dimensional feature points from the two-dimensional image, and calculate a plurality of coefficients in a transformation matrix based on a plurality of coordinates of the three-dimensional feature points and a plurality of coordinates of the two-dimensional feature points. The computing module performs a coordinate transformation process on the point cloud information or the two-dimensional image according to the transformation matrix.

In some embodiments, the target object is a three-dimensional chessboard.

In some embodiments, the computing module transforms the point cloud information to an orthographic projection direction, and binarizes the point cloud information to obtain a binary image, and obtains the three-dimensional feature points from the binary image.

In some embodiments, the computing module substitutes the coordinates of the three-dimensional feature points and the coordinates of the two-dimensional feature points into the following equation 1:

$$[ \begin{matrix}{x}_{i} \\ {y}_{i}\end{matrix} ] = M \cdot [ \begin{matrix}{x}_{c} \\ {y}_{c} \\ {z}_{c}\end{matrix} ] \qquad [ Equation 1 ]$$

wherein M is the transformation matrix, xᵢ is the X coordinate of the two-dimensional feature points, yᵢ is the Y coordinate of the two-dimensional feature points, x_{c} is the X coordinate of these three-dimensional feature points, y_{c} is the three-dimensional feature points Y coordinate, z_{c} is the Z coordinate of the three-dimensional feature points.

In some embodiments, the point cloud sensor is an underwater sonar sensor.

In some embodiments, the image sensor is a charge-coupled device (CCD) sensor.

In some embodiments, the target object includes concave blocks and convex blocks.

In some embodiments, the concave blocks correspond to a greater depth, and the convex blocks correspond to a smaller depth.

In some embodiments, the sensing system is used for underwater sensing.

The invention further provides a calibration method for point cloud and image. The calibration method includes: capturing point cloud information of a target object through a point cloud sensor; capturing a two-dimensional image of the target object through an image sensor; extracting a plurality of three-dimensional feature points from the point cloud information, and extracting a plurality of two-dimensional feature points from the two-dimensional image; calculating a plurality of coefficients in a transformation matrix based on a plurality of coordinates of the three-dimensional feature points and a plurality of coordinates of the two-dimensional feature points; and performing a coordinate transformation process on the point cloud information or the two-dimensional image according to the transformation matrix.

In some embodiments, the target object is a three-dimensional chessboard.

In some embodiments, extracting the three-dimensional feature points from the point cloud information includes: transforming the point cloud information to an orthographic projection direction, and binarizing the point cloud information to obtain a binary image, and obtaining the three-dimensional feature points from the binary image.

In some embodiments, the target object is a three-dimensional chessboard.

In some embodiments, extracting the three-dimensional feature points from the point cloud information includes: transforming the point cloud information to an orthographic projection direction, and binarizing the point cloud information to obtain a binary image, and obtaining the three-dimensional feature points from the binary image.

In some embodiments, calculating the coefficients in the transformation matrix based on the coordinates of the three-dimensional feature points and the coordinates of the two-dimensional feature points includes: substituting the coordinates of the three-dimensional feature points and the coordinates of the two-dimensional feature points into the following equation 1:

$$[ \begin{matrix}{x}_{i} \\ {y}_{i}\end{matrix} ] = M \cdot [ \begin{matrix}{x}_{c} \\ {y}_{c} \\ {z}_{c}\end{matrix} ] \qquad [ Equation 1 ]$$

wherein M is the transformation matrix, xᵢ is the X coordinate of the two-dimensional feature points, yᵢ is the Y coordinate of the two-dimensional feature points, x_{c} is the X coordinate of these three-dimensional feature points, y_{c} is the three-dimensional feature points Y coordinate, z_{c} is the Z coordinate of the three-dimensional feature points.

In some embodiments, the point cloud sensor is an underwater sonar sensor.

In some embodiments, the target object includes concave blocks and convex blocks.

In some embodiments, the concave blocks correspond to a greater depth, and the convex blocks correspond to a smaller depth.

In some embodiments, the sensing system is used for underwater sensing.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows.

FIG. 1 is a schematic diagram showing a sensing system for point cloud and image according to an embodiment of the present invention.

FIG. 2 is a schematic diagram showing point cloud information according to an embodiment of the present invention.

FIG. 3 is a schematic diagram showing a binary image according to an embodiment of the present invention.

FIG. 4 is a cross-sectional view of a three-dimensional chessboard before/after a coordinate transformation process is performed e according to an embodiment of the present invention.

FIG. 5 is a flow chart showing a calibration method for point cloud and image according to an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

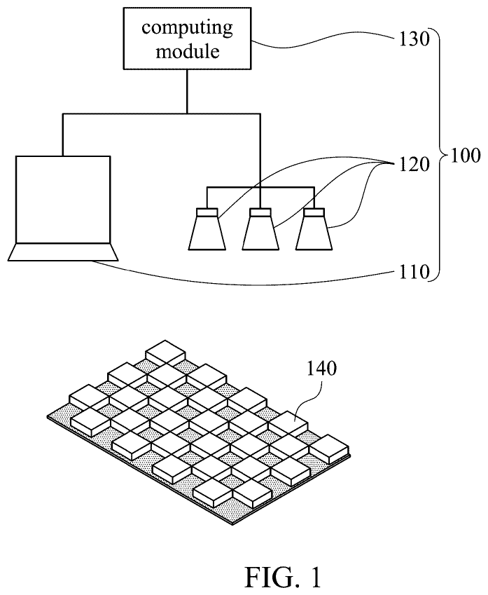

FIG. 1 is a schematic diagram showing a sensing system for point cloud and image according to an embodiment of the present invention. Referring to FIG. 1, the sensing system 100 includes an image sensor 110, a point cloud sensor 120 and a computing module 130. The image sensor 110 may include a charge-coupled device (CCD) sensor, a complementary metal-oxide semiconductor (Complementary Metal-Oxide Semiconductor) sensor, or other suitable photosensitive elements. The point cloud sensor 120 may be an underwater sonar sensor, a lidar, a laser scanner, or a structured light scanner that can obtain a point cloud. In some embodiments, plural point cloud sensors 120 can be arranged in an array or matrix. In addition, the point cloud sensors 120 can be line scanners or area scanners, and the present invention is not limited thereto. The computing module 130 can be a personal computer, a notebook computer, a server, a distributed computer, a central processing unit, or any electronic device/systems with computing capabilities. The computing module 130 is used to perform a point cloud and image calibration method, in which a target object 140 is used for calibration between the image sensor 110 and the point cloud sensor 120. In this embodiment, the target object 140 is a three-dimensional chessboard. The white part of the chessboard is convex and the black part of the chessboard is concave, but the present invention is not limited thereto. In other embodiments, the target for calibration can be any three-dimensional object.

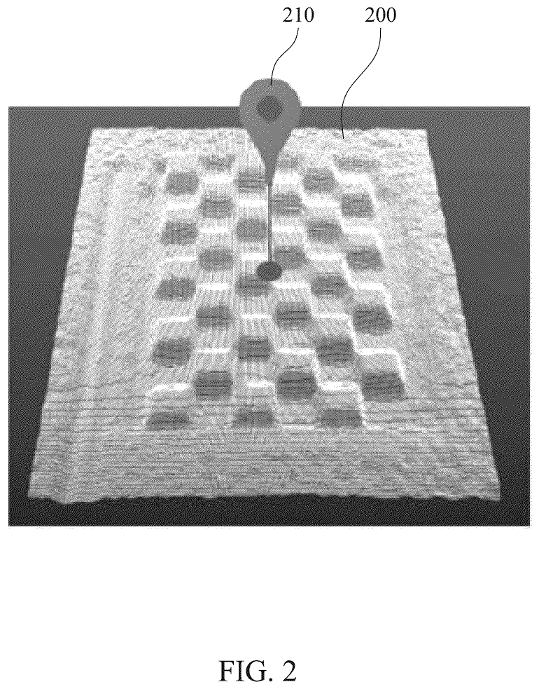

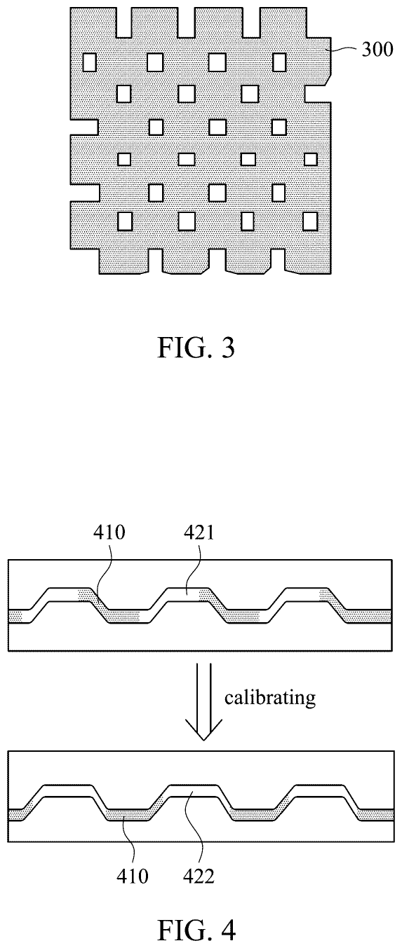

At first, the point cloud sensor 120 is used to capture point cloud information of the target object 140. A schematic diagram of the point cloud information 200 is shown as FIG. 2. The point cloud sensor 120 corresponds to the scanning center position 210. The point cloud information 200 includes plural points, and the coordinate of each of the points can be expressed as a vector (x_{c}, y_{c}, z_{c}) representing the X coordinate, the Y coordinate and the Z coordinate respectively. In this embodiment, the X coordinate represents the horizontal direction, the Y coordinate represents the vertical direction, and the Z coordinate represents the depth, but the present invention is not limited thereto. Here, some pre-processing operations can be performed on the point cloud information, such as removing noise and deleting the background. Thereafter, the point cloud information is transformed to the orthographic projection direction. For example, an operation for multiplying a rotation matrix by the coordinates is performed to calculate the positions of the point cloud under different viewing angles. This orthographic projection direction refers to the normal vector of a plane of the three-dimensional chessboard. Therefore, the blocks on the chessboard can be clearly distinguished. Then, the point cloud information is binarized to obtain a binary image. Here, each of the points in the point cloud can be classified into a class of white block or a class of black block on the chessboard according to the depth (Z coordinate). For example, a threshold value is predetermined, and the point has a depth greater than the threshold value is classified into the class of black block, and the point has a depth smaller than or equal to the threshold value is classified into the class of white block. Alternatively, in some embodiments, a clustering algorithm, such as the k-mean algorithm, can be performed on the points in the point cloud information to classify the points into two clusters, but the present invention is not limited thereto. Thereafter, one of the white block or the black block is set to “1”, and the other is set to “0”, thereby generating a binary image 300 as shown in FIG. 3. In order to perform calibration, it is required to extract plural three-dimensional feature points from the point cloud information. For example, the four corners of the white block and the black block in the binary image 300 are identified, and each of the corners is considered as a three-dimensional feature point. Therefore, each of the three-dimensional feature points has three coordinate values (x_{c}, y_{c}, z_{c}). Any image processing algorithm or machine learning algorithm can be used for the above identification process, and the present invention is not limited thereto.

Turning back to FIG. 1, on the other hand, the image sensor 110 captures a two-dimensional image of the target object 140. The two-dimensional image is, for example, a color image. Similarly, in order to perform calibration, it is required to identify two-dimensional feature points in the two-dimensional image. For example, the four corners of the white block and the black block in the two-dimensional image can be identified through image processing algorithms or machine learning algorithms. Each of the corners is a two-dimensional feature point, and each of the two-dimensional feature points can be represented as (xᵢ, yᵢ), where xᵢ is the X coordinate of the two-dimensional feature point and yᵢ is the Y coordinate of the two-dimensional feature point.

Then, plural coefficients in a transformation matrix are calculated based on the coordinates (x_{c}, y_{c}, z_{c}) of the three-dimensional feature points and the coordinates (xᵢ, yᵢ) of the two-dimensional feature points. Specifically, in the above identification process, it is understood that each of the three-dimensional feature points and the two-dimensional feature points corresponds to which corner of which block on the chessboard. Therefore, each of the coordinates (x_{c}, y_{c}, z_{c}) has a corresponding coordinate (xᵢ, yᵢ), and the coordinate (x_{c}, y_{c}, z_{c}) and the corresponding coordinate (xᵢ, yᵢ) belong to the same corner. Thereafter, the coordinates (x_{c}, y_{c}, z_{c}) and the corresponding coordinates (xᵢ, yᵢ) are substituted into the following equation 1:

$$[ \begin{matrix}{x}_{i} \\ {y}_{i}\end{matrix} ] = M \cdot [ \begin{matrix}{x}_{c} \\ {y}_{c} \\ {z}_{c}\end{matrix} ] \qquad [ Equation 1 ]$$

M is the transformation matrix having a size 2×3. In other words, the transformation matrix has six coefficients. Each of the three-dimensional feature points and the corresponding two-dimensional feature point form a set of solution. While the number of solutions is greater than or equal to 6, any optimization algorithm or regression algorithm can be used to calculate the coefficients in the transformation matrix M.

After the transformation matrix is solved, the calibration is completed. Thereafter, a coordinate transformation process can be performed on the point cloud information or the two-dimensional image based on this transformation matrix. Specifically, each of the coordinates (xᵢ, yᵢ) in the two-dimensional image can be substituted into the above equation 1 (the transformation matrix M is known at this time), so that the corresponding coordinates (x_{c}, y_{c}, z_{c}) of the point cloud information can be calculated. On the other hand, each of the points (x_{c}, y_{c}, z_{c}) in the point cloud information can also be substituted into the above equation 1 to obtain the corresponding coordinates (xᵢ, yᵢ) of the two-dimensional image. No matter which way is used, the two-dimensional image and point cloud information can be accurately overlapped after the coordinate transformation process is performed as shown in FIG. 4 representing the result of the overlapped two-dimensional image and the point cloud information. In FIG. 4, a cross section 410 of the three-dimensional chessboard in the X direction is illustrated according to the point cloud information. Because the chessboard has concave and convex blocks, the cross section 410 has ups and downs accordingly. On the other hand, if the two-dimensional image is directly overlapped with the point cloud information before the calibration process is performed, the white block 421 cannot accurately overlap with the convex portion on the cross section 410. After the above calibration process is performed, it can be seen that the white block 422 overlaps with the convex portion on the cross section 410 more accurately.

After the calibration process is performed, the above sensing system 100 can be used for underwater sensing. For example, sonar can be used to obtain point cloud information, and then the point cloud information is combined with two-dimensional images to provide information such as the depth, texture, and color of various objects on the seabed. However, the present invention does not limit the scenarios or products to which the sensing system 100 is applied.

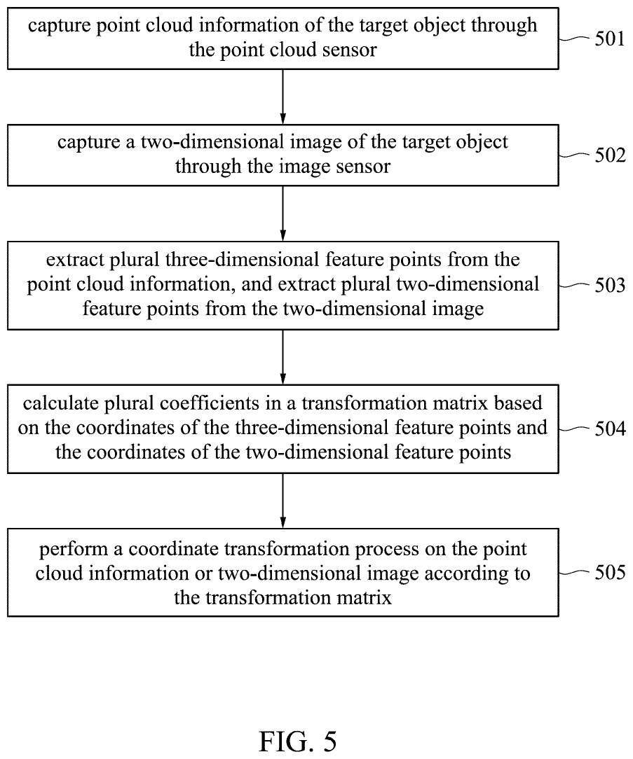

FIG. 5 is a flow chart showing a calibration method for point cloud and image according to an embodiment of the present invention. Referring to FIG. 5, at step 501, point cloud information of the target object is captured through the point cloud sensor. At step 502, a two-dimensional image of the target object is captured through the image sensor. At step 503, plural three-dimensional feature points are extracted from the point cloud information, and plural two-dimensional feature points are extracted from the two-dimensional image. At step 504, plural coefficients in a transformation matrix are calculated based on the coordinates of the three-dimensional feature points and the coordinates of the two-dimensional feature points. At step 505, a coordinate transformation process is performed on the point cloud information or two-dimensional image according to the transformation matrix. Each of the steps in FIG. 5 is described in detail above and not be repeated here. It is noted that each of the steps in FIG. 5 can be implemented as plural program codes executed by a computer system or implemented as a circuit. However, the present invention is not limited thereto. In addition, the method in FIG. 5 can be used in conjunction with the above embodiments or can be used alone. In other words, other steps can be added between the steps in FIG. 5.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A point cloud and image sensing system, comprising:
a point cloud sensor configured to capture point cloud information of a target object;
an image sensor configured to capture a two-dimensional image of the target object; and
a computing module communicatively connected to the point cloud sensor and the image sensor, wherein the computing module is configured to extract a plurality of three-dimensional feature points from the point cloud information, and extract a plurality of two-dimensional feature points from the two-dimensional image, and calculate a plurality of coefficients in a transformation matrix based on a plurality of coordinates of the three-dimensional feature points and a plurality of coordinates of the two-dimensional feature points;
wherein the computing module performs a coordinate transformation process on the point cloud information or the two-dimensional image according to the transformation matrix.

2. The sensing system of claim 1, wherein the target object is a three-dimensional chessboard.

3. The sensing system of claim 2, wherein the computing module transforms the point cloud information to an orthographic projection direction, and binarizes the point cloud information to obtain a binary image, and obtains the three-dimensional feature points from the binary image.

4. The sensing system of claim 3, wherein the computing module substitutes the coordinates of the three-dimensional feature points and the coordinates of the two-dimensional feature points into the following equation 1:
$$[ \begin{matrix}{x}_{i} \\ {y}_{i}\end{matrix} ] = M \cdot [ \begin{matrix}{x}_{c} \\ {y}_{c} \\ {z}_{c}\end{matrix} ] \qquad [ Equation 1 ]$$
wherein M is the transformation matrix, xᵢ is the X coordinate of the two-dimensional feature points, yᵢ is the Y coordinate of the two-dimensional feature points, x_{c} is the X coordinate of these three-dimensional feature points, y_{c} is the three-dimensional feature points Y coordinate, z_{c} is the Z coordinate of the three-dimensional feature points.

5. The sensing system of claim 1, wherein the point cloud sensor is an underwater sonar sensor.

6. The sensing system of claim 1, wherein the image sensor is a charge-coupled device (CCD) sensor.

7. The sensing system of claim 1, wherein the target object comprises concave blocks and convex blocks.

8. The sensing system of claim 7, wherein the concave blocks correspond to a greater depth, and the convex blocks correspond to a smaller depth.

9. The sensing system of claim 7, wherein the sensing system is used for underwater sensing.

10. A calibration method for point cloud and image, executed by a computer system, wherein the calibration method comprises:
capturing point cloud information of a target object through a point cloud sensor;
capturing a two-dimensional image of the target object through an image sensor;
extracting a plurality of three-dimensional feature points from the point cloud information, and extracting a plurality of two-dimensional feature points from the two-dimensional image;
calculating a plurality of coefficients in a transformation matrix based on a plurality of coordinates of the three-dimensional feature points and a plurality of coordinates of the two-dimensional feature points; and
performing a coordinate transformation process on the point cloud information or the two-dimensional image according to the transformation matrix.

11. The calibration method of claim 10, wherein the target object is a three-dimensional chessboard.

12. The calibration method of claim 11, wherein extracting the three-dimensional feature points from the point cloud information comprises:
transforming the point cloud information to an orthographic projection direction, and binarizing the point cloud information to obtain a binary image, and obtaining the three-dimensional feature points from the binary image.

13. The calibration method of claim 12, wherein calculating the coefficients in the transformation matrix based on the coordinates of the three-dimensional feature points and the coordinates of the two-dimensional feature points comprises:
substituting the coordinates of the three-dimensional feature points and the coordinates of the two-dimensional feature points into the following equation 1:
$$[ \begin{matrix}{x}_{i} \\ {y}_{i}\end{matrix} ] = M \cdot [ \begin{matrix}{x}_{c} \\ {y}_{c} \\ {z}_{c}\end{matrix} ] \qquad [ Equation 1 ]$$
wherein M is the transformation matrix, xᵢ is the X coordinate of the two-dimensional feature points, yᵢ is the Y coordinate of the two-dimensional feature points, x_{c} is the X coordinate of these three-dimensional feature points, y_{c} is the three-dimensional feature points Y coordinate, z_{c} is the Z coordinate of the three-dimensional feature points.

14. The calibration method of claim 10, wherein the point cloud sensor is an underwater sonar sensor.

15. The calibration method of claim 10, wherein the target object comprises concave blocks and convex blocks.

16. The calibration method of claim 15, wherein the concave blocks correspond to a greater depth, and the convex blocks correspond to a smaller depth.

17. The calibration method of claim 10, wherein the computer system is used for underwater sensing.
